(19) United States
(12) Patent Application Publication
(10) Pub. No.: US 2005/0125801 A1
(43) Pub. Date: Jun. 9, 2005

(54) Method and apparartus for context switching in computer operating systems

(76) Inventor: Colin King, Crawley (GB)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(21) Appl. No.: 10/509,220

(22) PCT Filed: Feb. 14, 2003
(86) PCT No.: PCT/IB03/00626

(30) Foreign Application Priority Data
Mar. 28, 2002 (GB) 0207296.5

(51) Int. Cl. G06F 9/46

(52) U.S. Cl. 718/108

(57) ABSTRACT

The present invention provides for a method and apparatus for a computer implemented system including a processor and cache memory arranged to receive operating system instructions for context switching between processes, and including control means for writing back cache data to memory means during processor idle cycle at completion of a process, and prior to initiation of the context switch so as to enhance the operating speed since, at the time of initiating the context switch, the cached data has already been written back to memory.

The present invention relates to a method and apparatus for context switching in computer operating systems.

Operating systems are used within computer systems so as to increase the utilisation of the system's processor. In view of the difference in operating speed between the processor and, for example input output devices, the operating system advantageously serves to schedule instructions to the processor in order to limit the time period for which the processor might otherwise remain idle due to its faster operating speed.

With developments in multitasking, and multithreading, an increasing number of interruptions are required to be handled by the operating system and correspondingly frequent context switches between different processes are then required.

With, for example, UNIX-like kernels, the switching between running processes should be as fast as possible and employ the minimum possible number of processor cycles. However, before a context switch to a new process can be achieved, the cached data of the previously running process may be written back to memory for consistency between the contents of the cache and memory. The time taken to write the cached data back to memory once it has been identified that a context switch is to be conducted is a disadvantageously limiting feature with regard to the overall time required to execute the context switch.

Attempts have been made to reduce context switching time as illustrated for example in U.S. Pat. No. 6,006,320. Here a duplicate arithmetic logic unit, instruction and data cache, register set and load/store unit are provided in an attempt to speed up the context switching process. However, such an approach to this problem can be considered disadvantageous in requiring the aforementioned duplication of hardware and proves to be unnecessarily complex.

The present invention therefore seeks to provide for a simplified solution to the problem of context switching time delays.

According to one aspect of the present invention there is provided a method of context switching between processes in a computer operating system including writing cached data back to a memory means, comprising the step of the writing cached data back to the memory means during processor idle cycles at completion of a process and prior to initiation of the context switch.

The invention is advantageous in that it employs the idle loop entered by the processor once, for example, a runnable process has completed and while the processor is waiting for the next event, such as the completion of an input/output operation, to occur. During such an idle loop, spare processor cycles are lost and the present invention advantageously makes use of such cycles in order to write-back the cached data to memory.

Thus, at the end of a process, cached data can somewhat automatically be written back to memory so that, should a context switch be required, there is then no need to first write back the cached data to memory before commencing with the context switch. This can increase substantially the switching time required for context switches in an operating system.

The feature of claim 2 is advantageous in providing for an effective means for indicating that cached data write-back has occurred so as to lead to appropriate subsequent control steps depending on whether a context switch is required or not.

The subject matter of claims 3-5 advantageously further adapts the subject matter of claim 2 in a particularly effective manner so as to lead to a suitable form of process switching as required.

According to another aspect of the present invention, there is provided a computer implemented system including a processor and cache memory arranged to receive operating system instructions for context switching between processes, and including control means for writing back cached data to memory means during processor idle cycles at completion of a process, and prior to initiation of the context switch.

In accordance with a further aspect of the present invention, there is provided a computer program product having computer program instructions and arranged for controlling context switching between processes in a computer operating system so as to write cached data back to memory means during processor idle cycles at completion of a process and prior to initiation of the context switch.

As will be appreciated the present invention can therefore be provided as a software, or hardware, solution to the problem discussed above.

The present invention is described further hereinafter, by way of example only, with reference to the accompanying drawings in which:

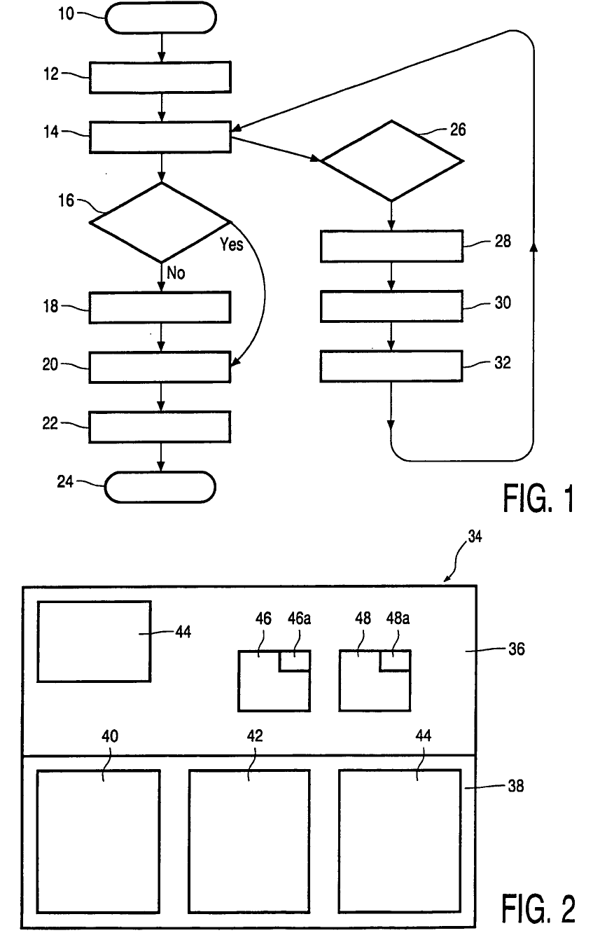

FIG. 1 is a flow diagram of a context switching operation according to an embodiment of the present invention;

FIG. 2 is a schematic block diagram of a computer system including an operating system and related control means according to an embodiment of the present invention; and

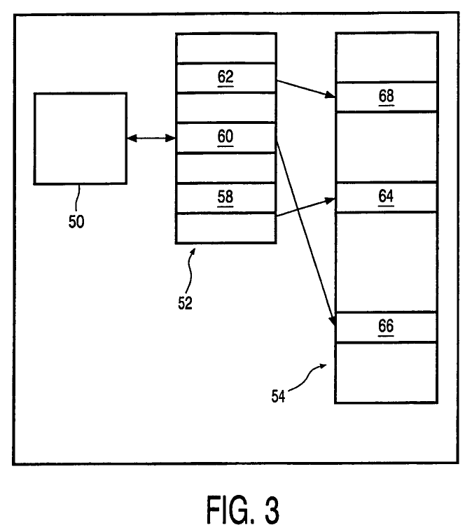

FIG. 3 is a schematic block diagram of a computer system embodying the present invention and illustrating the transfer of cached pages.

As will be appreciated, the invention proposes the use of idling time to write the cached data back to memory of the last running process, hence removing the time penalty of this operation at process switching time. Once the cached data has been written back to memory, a flag for that process is set to indicate that it has been done.

When a switch between runnable processes occurs, the last runnable processes's flag is checked to see if its cached data has been written back during a CPU idle, and if set, the switch does not need to write cache back. However, if the CPU idle has not been entered, and hence the last runnable processes's flag is not set, then the process switching operating need to write the cache back.

The resulting advantage is that for a system that has free CPU idle time, switching between processes is faster and the system becomes more responsive to the user. With current fast processors, processor idle time is available for most moderately loaded systems. Processor idle time also occurs when processes are using Input/Output steps and the processor is waiting for these transactions to complete.

Turning first to FIG. 1, there is provided a flow diagram illustrating an embodiment of the present invention in which a current process 10 is to be rescheduled 12. At step 14 a search for the next runnable process is made and, if one is located, a check at 16 is made to ascertain if the previous running process's flag has been set. If no flag has been set then a decision is made at 18 to copy back the cache of the previous running process and the flag of the next runnable process identified at 14 is cleared at 20. If at 14 it was determined that the previous running process's flag had been set, then the method skips on to block 20 directly. At 22 the context switch to the new process is made and, at 24, the new process becomes the currently running process.

Back at block 14, should a next runnable process not have been found, then the method checks to see if the previous running process's flag has been set. If the flag has not been set, then the cached data is copied back at 28 and a flag in the previous running process's process descriptor is set at 30. A sleep mode is then entered at 32 until, for example, an interrupt occurs and the method returns to block 14 as part of an idle loop.

If at block 26 it is determined that the previous running process's flag has been set, then the method skips to block 30 as illustrated.

FIG. 2 illustrates computer system 34 embodying the present invention and which comprises the operating system kernel 36 and user mode processes 38. The user mode processes comprises three processes 40, 42 and 44 and the system illustrates the process 40 being blocked such that a scheduler 44 reschedules to process 42. Each of the runnable processes is associated with a respective runnable process list 46, 48 having respective flags 46a, 48a. The configuration illustrated in FIG. 2 is such as to illustrate a context switch between processes and the manner in which the runnable process descriptor lists point to identify the runnable processes.

Lastly, FIG. 3 illustrates a CPU 50, data cache 52 and memory 54 of a computer system 56, and illustrates inparticular the manner in which cached pages 58-62 are written back to respective memory locations 64-68 of the memory in accordance with the present invention. As will be appreciated, the data cache pages 58-62 are written back to the memory 54 if the process's flag is not set.

Analysis on a Philips TriMedia 1300 (with an external memory manager unit) prototype board has shown that a typical 1 Mb user mode application takes about 6000-7000 CPU cycles to write the process's data cache back to memory, which is about 30-50% of the total context switch time. With the data cache being written to memory during CPU idle time, the context switch time loses this 30-50% overhead and so almost doubles the context switch speed. It will of course be appreciated that these figures vary, depending on the size of the application and the number of cached regions of memory.

The present invention finds particular use in UNIX-like systems, such as Linux, FreeBSD, Solaris, etc and that use a processor with a level-1 or level-2 cache. All such UNIX-like systems have an idle loop, or idle process, that employ effectively wasted CPU cycles, and most modern processors have some form of memory cache in, or between, the processor and main memory.

The present invention can therefore find use in most current computer operating systems.

As noted before, the invention can comprise a software, or hardware, solution to the problem of the prior art. If the idea is implemented in hardware, one of a variety of methods could be used. For example, the CPU sleep mode could be employed for the data cache write-back automatically during a sleep period. Also, “flush data cache during sleep” flag in a status register could be employed to inform the CPU sleep operation to conduct the data cache write-back. Further, an extra sleep op-code could be added that performs the data cache write-back, in addition to the normal sleep op-code. The addition of a data cache write-back operand to a CPU sleep opcode is also an option.

Thus, as will be appreciated, the present invention advantageously employs processor idle time to accelerate, and simplify, context switching in computer operating systems. The invention overcomes the problem of relatively slow context switching speeds between runnable processes/tasks which arises due to the general requirement to write cached data back to memory. Since, in the prior-art, this writing-back of cached memory is carried out at the time of the actual context switch, the employment of otherwise spare processor cycles in the idle loop of the operating system advantageously serves to enhance the operating speed since, at the time of initiating the context switch, the cached data has already been written back to memory.

1. A method of context switching between processes in a computer operating system including writing cached data back to a memory means, comprising the step of the writing cached data back to the memory means during processor idle cycles at completion of a process and prior to initiation of the context switch.

2. A method as claimed in claim 1, including the step of setting a flag to indicate cached data has been written back to memory subsequent to the completion of the process.

3. A method as claimed in claim 2, including the step of, at the time of requiring a context switch, checking for the said flag to identify if the previous process's cached data has been written back to memory.

4. A method as claimed in claim 3, including the step of, upon identifying that the said flag has been set, conducting the context switch without further cache write-back to memory.

5. A method as claimed in claim 3, and including the step of conducting a cached data write-back to memory at the time of requiring a context switch if the said flag has not been identified as set.

6. A computer implemented system including a processor and cache memory arranged to receive operating system instructions for context switching between processes, and including control means for writing back cache data to memory means during processor idle cycle at completion of a process, and prior to initiation of the context switch.

7. A system as claimed in claim 6, and arranged to employ a processor sleep mode to write cache data back to memory automatically during a sleep period.

8. A system as claimed in claim 6, and including a status register having a flag for initiating data cache write-back during a CPU sleep operation.

9. A system as claimed in claim 6, wherein the operating system is arranged with an additional sleep code instruction for the data cache write-back

10. A system as claimed in claim 9, wherein the sleep code of the processor includes an additional data cache write-back instruction.

11. A computer program product having computer program instructions and arranged for controlling context switching between processors in a computer operating system so as to write cached data back to memory means during processor idle cycles at completion of a process and prior to initiation of the context switch.

12. (canceled)
